(19) United States
(12) Patent Application Publication
(10) Pub. No.: US 2024/0399915 A1
(43) Pub. Date: Dec. 5, 2024

(54) ELECTRIC VEHICLE CHARGING SYSTEMS AND METHODS

(71) Applicant: Dynamic EV Charging Inc., Oakville (CA)

(72) Inventors: Dusan Veselic, Oakville (CA); Jorgen John Moller, Oakville (CA)

(73) Assignee: Dynamic EV Charging Inc., Oakville (CA)

(21) Appl. No.: 18/732,936

(22) Filed: Jun. 4, 2024

Related U.S. Application Data
(60) Provisional application No. 63/521,193, filed on Jun. 15, 2023.
(60) Provisional application No. 63/471,085, filed on Jun. 5, 2023.

(51) Int. Cl. B60L 53/63; B60L 53/16; B60L 53/62; B60L 53/66; B60L 53/67

(52) U.S. Cl. CPC B60L 53/63; B60L 53/16; B60L 53/62; B60L 53/66; B60L 53/67

(57) ABSTRACT

Flexible and scalable systems and methods for charging electric vehicles (EVs) are disclosed. For example, a system may be configured to dynamically adjust the amount of power available to one or more EVs based on real-time measurements of a residential load. In some implementations, the system may be configured to ensure that the combined load of the EVs and the residential load does not exceed a predetermined threshold. The predetermined threshold may be based on the power capacity and electrical specifications of an existing building. As a result, the system can be added to an existing building without overloading the grid and/or without significantly altering the power infrastructure of the building.

### CROSS REFERENCE TO RELATED APPLICATIONS

The present application claims the benefit of U.S. Provisional Application No. 63/521,193, filed Jun. 15, 2023, and U.S. Provisional Application No. 63/471,085, filed Jun. 5, 2023, both of which are incorporated herein by reference.

### TECHNICAL FIELD

Aspects of the present technology relate to automated systems and methods for charging electric vehicles (EVs).

### BACKGROUND

The widespread adoption of electric vehicles (EVs) is driving significant political and economic change globally. In response, many countries are setting ambitious goals to phase out fossil-fuel car production and sales in the near future (2035 for Canada). As a result, there is a significant focus on increasing availability and accessibility of EV charging infrastructure across the world. One example of such an initiative is the Zero Emission Infrastructure Program, which the Canadian government continues to make significant investments into. The program places great emphasis on addressing the shortage of EV accessibility in public spaces, workplaces, and multi-unit residential buildings. It is estimated that around one-third of all Canadians currently reside in an apartment or condo unit. Along with the rising trend of condominium construction, this presents a unique challenge for EV owners, as it highlights the urgency to address the lack of charging infrastructure in multi-unit residential buildings.

EV battery-charging units are also called electric vehicle service equipment (EVSE). There are three types-levels 1-3, as established by Society of Automotive Engineers (SAE) standard. Levels 1 and 2 supply power to an on-board charger built into the EV. Level 3 uses a power-conversion stage built within an external charger and bypasses the on-board charger on the EV. A level 1 EVSE uses a commonly available 120 VAC (single phase) power line and ranges in output from 1.44 kW (12 A at 120V) to 9.6 kW (80 A at 120V). It can take 35 hours to fully charge a 50 KWH Tesla model 3 battery (at 1 C charge rate) with a level 1 EVSE. A level 2 EVSE uses a 240 VAC power line in combination with a more robust vehicle charger. It can deliver up to 19.2 kW (80 A at 240V), which can completely charge the same 50 KWH battery in about three hours. A level 3 EVSE uses an external charger that supplies high voltage (e.g., 300 VDC to 750 VDC) at up to 400 A directly to an EV's battery. It can take less than 30 minutes to fully charge a 50 KWH Tesla model 3 battery (at 2 C charge rate) with a level 3 EVSE. Residential charging stations are often level 1 or 2, while public charging stations are often level 2 or 3.

Level 1 and 2 charging units typically include a split phase 120/240 VAC power line that is distributed to a power supply for monitoring, control, and communications circuits. The power line also encounters sensor circuitry that monitors and filters the current and voltages in the system. The monitored and/or filtered power is typically applied to high-current contacts on a relay before connecting to a connector of an EV (e.g., a J1772 connector). A microcontroller often manages the monitoring, control, and communications circuits. Level 3 charging units similarly include a microcontroller and monitoring, control, and communications circuits. However, instead of sensor circuitry and a relay, level 3 charging units may include a power-factor-correction (PFC) circuit and a DC/DC converter. Additional information regarding existing configurations of level 1-3 charging units can be found in, for example, Bart Basille & Jayanth Rangaraju, Which new semiconductor technologies will speed electric vehicle charging adoption?, Texas Instruments (2017), which is incorporated herein by reference.

One of the key challenges of adding EV battery-charging units to multi-unit residential buildings is limited power. For example, existing condominiums often have a power infrastructure that is designed to accommodate the residences and existing amenities. EVSEs are new amenities that can require a substantial amount of additional power. Another challenge is the time and cost required to add EV battery-charging units to multi-unit residential buildings. Expanding a power infrastructure is a timely and costly effort. As residents gradually adopt EVs, it can take long time to recover these costs. Yet another challenge is the potential to overload the grid. Installing standard level 2 charging units in a number of multi-unit residential buildings within a single neighborhood would significantly increase the power demand for that neighborhood. Such a sudden increase may not provide sufficient time for the grid to be updated where needed.

As a result, there is a need for systems and methods that can address one or more of the above-noted challenges. For example, there is a need for development of flexible and scalable systems for multi-unit residential buildings.

### BRIEF SUMMARY

Flexible and scalable systems and methods for charging electric vehicles (EVs) are disclosed. For example, a system may be configured to dynamically adjust the amount of power available to one or more EVs based on real-time measurements of a residential load. In some implementations, the system may be configured to ensure that the combined load of the EVs and the residential load does not exceed a predetermined threshold. The predetermined threshold may be based on the power capacity and electrical specifications of an existing building. As a result, the system can be added to an existing building without overloading the grid and/or without significantly altering the power infrastructure of the building.

One aspect of the present disclosure relates to a system comprising a sensor for measuring a power drawn by a prioritized electrical load, an electrical circuit for controlling and distributing power to an electric vehicle, and one or more processors. The one or more processors are configured to receive, from the sensor, a measurement indicating the power drawn by the prioritized electrical load, compare the power drawn by the prioritized electrical load to a predetermined threshold to determine an amount of power available for charging the electric vehicle, and communicate, to the electric vehicle, the determined amount of power available for charging the electric vehicle.

In some implementations, the predetermined threshold corresponds to a maximum amount of power that can be drawn by the prioritized electrical load. In some implementations, the prioritized electrical load comprises residential electrical devices, such as such as water heaters, heating, ventilation, and air conditioning (HVAC) systems, refrigerators, stoves, ovens, microwaves, washing machines, computers, televisions, lights, fans, and any other electrical devices used by the residents of a building. In some implementations, a single electrical panel comprises the electrical circuit and the one or more processors. In some implementations, the single electrical panel further comprises the sensor.

In some implementations, the sensor comprises an RMS to DC converter, a current transformer, a Rogowski Coil, a shunt resistor, or a Hall effect current sensor. In some implementations, the sensor comprises an RMS to DC converter, and an output of the RMS to DC converter is coupled to an input of an analogue to digital converter in communication with the one or more processors.

In some implementations, the system further comprises an additional sensor for measuring a power drawn by the electric vehicle, and the one or more processors are further configured to receive, from the additional sensor, a measurement indicating the power drawn by the electric vehicle, and generate an alert when the power drawn by the electric vehicle is above a first predetermined threshold or below a second predetermined threshold.

In some implementations, the system further comprises an additional sensor for measuring a power drawn by the electric vehicle, the electrical circuit comprises one or more switches, and the one or more processors are further configured to receive, from the additional sensor, a measurement indicating the power drawn by the electric vehicle, and control the one or more switches to automatically open when the power drawn by the electric vehicle is above a first predetermined threshold or below a second predetermined threshold.

In some implementations, after communicating, to the electric vehicle, the determined amount of power available for charging the electric vehicle, the one or more processors are further configured to receive, from the sensor, an additional measurement indicating the power drawn by the prioritized electrical load, adjust the determined amount of power available for charging the electric vehicle, and communicate, to the electric vehicle, the adjusted amount of power available for charging the electric vehicle. In some implementations, the electrical circuit comprises one or more switches, and the one or more processors are further configured to control the one or more switches to open before communicating, to the electric vehicle, the adjusted amount of power available for charging the electric vehicle. In some implementations, the one or more processors communicate the adjusted amount of power available for charging the electric vehicle through a pilot line of a J1772 connector.

In some implementations, the system further comprises a plurality of switching mechanisms that can be opened or closed to change at least one of (a) phases of an AC power source that are connected to the electric vehicle, (b) a level of power that is provided to the electric vehicle, or (c) a number of phases of power that are delivered to the electric vehicle, wherein at least one of the sensor or an additional sensor is configured to measure loads on two or more of the phases of the AC power source, and wherein the one or more processors are further configured to control the plurality of switching mechanisms to open or close based on the measured loads. In some implementations, the one or more processors are configured to control the plurality of switching mechanisms to connect the phase of the AC power source that is least loaded to the electric vehicle. In some implementations, the one or more processors are configured to control the plurality of switching mechanisms to provide level 2 charging to the electric vehicle when two or more of the phases of the AC power source are less loaded than one or more other phases of the AC power source. In some implementations, the one or more processors are configured to control the plurality of switching mechanisms to change how many phases of power are delivered to the electric vehicle.

Another aspect of the present disclosure relates to a system comprising a main power distribution and supervisory control module and a plurality of charging modules. The main power distribution and supervisory control module is configured to receive power from an electrical grid, measure a power drawn by a prioritized electrical load, and compare the power drawn by the prioritized electrical load to a predetermined threshold to determine an amount of power available for charging one or more electric vehicles. Each one of the plurality of charging modules is configured to receive power from the main power distribution and supervisory control module and distribute it to one or more connected electrical vehicles, receive a communication from the main power distribution and supervisory control module indicating how much power can be collectively drawn by the one or more connected electrical vehicles, and transmit a communication to each of the one or more connected electrical vehicles indicating how much power the corresponding electrical vehicle can draw.

In some implementations, the power collectively received by the plurality of charging modules from the main power distribution and supervisory control module is less than or equal to the determined amount of power available for charging the one or more electric vehicles. In some implementations, the main power distribution and supervisory control module equally distributes power to the plurality of charging modules. In some implementations, the main power distribution and supervisory control module distributes more power to some of the plurality of charging modules.

Yet another aspect of the present disclosure relates to a system comprising a main power distribution and supervisory control module, a block power distribution and supervisory control module, and a plurality of charging modules. The main power distribution and supervisory control module is configured to receive power from an electrical grid, measure a power drawn by a prioritized electrical load, and compare the power drawn by the prioritized electrical load to a predetermined threshold to determine an amount of power available for charging one or more electric vehicles. The block power distribution and supervisory control module is configured to receive power from the main power distribution and supervisory control module, and receive a communication from the main power distribution and supervisory control module indicating how much power can be distributed by the block power distribution and supervisory control module. Each one of the plurality of charging modules is configured to receive power from the block power distribution and supervisory control module and distribute it to one or more connected electrical vehicles, receive a communication from the block power distribution and supervisory control module indicating how much power can be collectively drawn by the one or more connected electrical vehicles, and transmit a communication to each of the one or more connected electrical vehicles indicating how much power the corresponding electrical vehicle can draw.

In some implementations, the power received by the block power distribution and supervisory control module from the main power distribution and supervisory control module is less than or equal to the determined amount of power available for charging the one or more electric vehicles. In some implementations, the block power distribution and supervisory control module equally distributes power to the plurality of charging modules. In some implementations, the block power distribution and supervisory control module distributes more power to some of the plurality of charging modules.

### BRIEF DESCRIPTION OF DRAWINGS

FIG. 1 illustrates a system for controlling and distributing power to a plurality of electric vehicles (EVs).

FIG. 2 illustrates a circuit of interconnected modules in communication with one or more servers.

FIG. 3 illustrates the main power distribution and supervisory control module of FIG. 2 in greater detail.

FIG. 4 illustrates aspects of the circuit of FIG. 2 in greater detail that relate to the calculation of an amount of power available for EV charging.

FIG. 5 illustrates a modified version of the circuit of FIG. 4 that further includes a mechanism for generating an alert.

FIG. 6 illustrates one of the block power distribution and supervisory control modules of FIG. 2 in greater detail.

FIG. 7 illustrates aspects of the circuit of FIG. 2 in greater detail that relate to power monitoring.

FIG. 8 illustrates one of the charging modules of FIG. 2 in greater detail.

FIG. 9 illustrates a circuit diagram for a single-phase electric vehicle service equipment (EVSE) with a J1772 connector.

FIG. 10A illustrates a circuit diagram for a single-phase EVSE with a Mennekes connector.

FIG. 10B illustrates a circuit diagram for a two-phase EVSE with a Mennekes connector.

FIG. 10C illustrates a circuit diagram for a three-phase EVSE with a Mennekes connector.

FIG. 11 illustrates a circuit for switching which lines power a single-phase, level 1 EVSE.

FIG. 12 illustrates a circuit for switching which lines power a single-phase, level 2 EVSE.

FIG. 13 illustrates a circuit for switching the lines and/or power level of a single-phase EVSE.

FIG. 14 illustrates a circuit for switching which lines power a two-phase, level 2 EVSE.

### DETAILED DESCRIPTION

Implementations of the present disclosure are described in detail with reference to the drawing figures wherein like reference numerals identify similar or identical elements. It is to be understood that the disclosed implementations are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

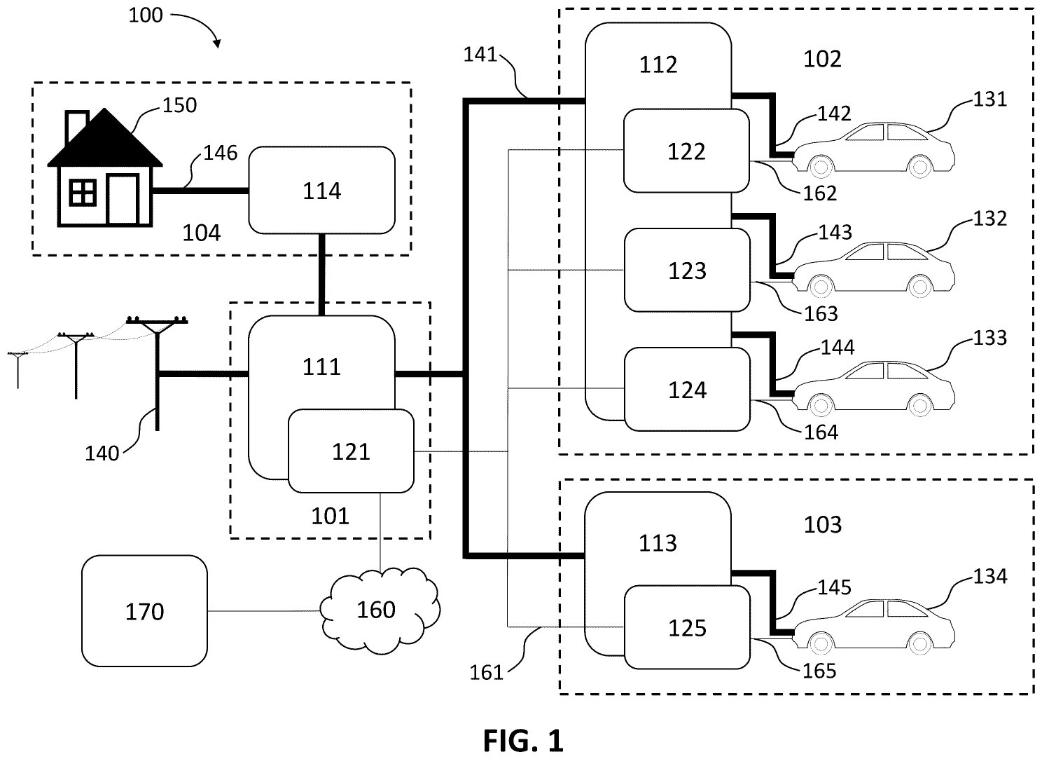

FIG. 1 illustrates a system for controlling and distributing power to a plurality of electric vehicles (EVs). As shown, system 100 includes zones 101-104, electrical panels 111-114 (also known as circuit breaker panels or breaker boxes), control modules 121-125, EVs 131-134, electrical grid 140, power distribution lines 141-146, prioritized load 150, network 160, communication lines 161-165, and server 170. Zone 101 includes electrical panel 111 and control module 121. Zone 102 includes electrical panel 112, control modules 122-124, and EVs 131-133. Zone 103 includes electrical panel 113, control module 125, and EV 134. Zone 104 includes electrical panel 114 and prioritized load 150. In some implementations, zones 101-104 may be in a multi-unit residential building. In such implementations, prioritized load 150 may include residential electrical devices, such as water heaters, heating, ventilation, and air conditioning (HVAC) systems, refrigerators, stoves, ovens, microwaves, washing machines, computers, televisions, lights, fans, and any other electrical devices used by the residents of the multi-unit residential building. In some implementations, zone 102 may be located in one parking area of the multi-unit residential building and zone 103 may be located in another parking area of the building (e.g., a different floor of a parking garage).

Power is distributed from electrical grid 140 to EVs 131-134 and prioritized load 150 via electrical panels 111-114 and power distribution lines 141-146. Electrical panel 111 is the main electrical panel. It receives power (e.g., 240 VAC) directly from electrical grid 140 and distributes the power to electrical panels 112-114, all of which are electrical subpanels. Electrical panel 112 then distributes the power to EVs 131-133 in zone 102. Similarly, electrical panel 113 distributes power to EV 134 in zone 103. Electrical panel 114 distributes power to prioritized load 150 in zone 104. Each one of electrical panels 111-114 may include one or more circuit breakers, one or more surge arresters, one or more transformers, one or more relays, one or more fuses, one or more terminal blocks, one or more buttons, one or more switches, and/or any other circuitry for controlling and distributing power. In some implementations, one or more of electrical panels 111-114 may also include additional circuitry for measuring the voltage, current, and/or power in real-time. For example, electrical panel 111 may include additional circuitry for measuring the power distributed to one or more of electrical panels 112-114. In some implementations, electrical panel 114 may also be a main electrical panel that receives power directly from electrical grid 140. In some such implementations, electrical panel 111 may be communicatively coupled to a sensor for measuring the power distributed to electrical panel 114 (and consequently prioritized load 150) in real-time.

In some implementations, system 100 may be configured such that the combined power load of EVs 131-134 and prioritized load 150 never exceeds a predetermined threshold (e.g., a power capacity of a building). In some such implementations, system 100 may be configured to increase or decrease the amount of power available to EVs 131-134 based on the power currently being drawn by prioritized load 150. For example, in some implementations, the power available to EVs 131-134 may be calculated as follows:

P_{EV}=P_{GRID}−P_{RES},

where P_{EV} is the total power available for EVs 131-134, P_{GRID} is the total power that can be drawn by EVs 131-134 and prioritized load 150 (e.g., the total power that can be drawn by a multi-unit residential building), and P_{RES} is the total power currently being drawn by prioritized load 150. In some implementations, system 100 may temporarily prioritize one zone over another. For example, rather than equally distributing all of P_{EV} between zone 102 and 103, system 100 may distribute most or all of P_{EV} to zone 102 during a particular time period.

Each one of control modules 121-125 may include one or more processors, one or more application specific integrated circuits (ASICs), and/or other similar components. Each one of control modules 121-125 may also include a memory medium, such as a hard-drive, memory card, ROM, RAM, DVD, CD-ROM, write-capable, and/or read-only memory, that is capable of storing information. Each one of control modules 121-125 may also include additional circuitry. For example, each one of control modules 121-125 may include a sensor and corresponding circuitry for measuring voltage, current, and/or power in real-time. For example, control module 121 may include additional circuitry for measuring the amount of power drawn by prioritized load 150. As another example, each one of control modules 122-125 may include additional circuitry for measuring the amount of power drawn by EVs 131-134, respectively. In some implementations, one or more of control modules 121-125 may include additional circuitry for externally processing data. For example, control module 121 may include additional circuitry for assisting with the calculation of P_{EV} in real-time.

In some implementations, control modules 121-125 may be integrated with one of electrical panels 111-113 in a single housing. For example, electrical panel 111 may be integrated with control module 121 in a single housing, electrical panel 112 may be integrated with control modules 122-124 in a single housing, and electrical panel 113 may be integrated with control module 125 in a single housing. In other implementations, one or more of control modules 121-125 may be incorporated into separate devices from electrical panels 111-113.

Control modules 121-125 are communicatively coupled to one another via communication lines 161-165. In some implementations, control modules 121-125 may communicate with one another using standard communications protocols, such as Inter-Integrated Circuit (I2C), Serial Peripheral Interface (SPI), Controller Area Network (CAN), Universal Asynchronous Reception and Transmission (UART), Ethernet, or Universal Serial Bus (USB), or custom communications protocols. In some implementations, some or all of control modules 121-125 may also communicate wirelessly with one another using standard communications protocols, such as Bluetooth, WiFi, ZigBee, Z Wave, NEC Infrared (IR), Code Division Multiple Access (CDMA), Global System for Mobile Communications (GSM), or Long-Term Evolution (LTE), or custom communications protocols. In some implementations, some or all of communication lines 161-165 may be removed from system 100, and some or all of control modules 121-125 may communicate wirelessly with one another instead of through a wired connection.

Control modules 122-125 are also communicatively coupled with EVs 131-134, respectively. In some implementations, control modules 122-125 may communicate with EVs 131-134 using standard communications protocols, such as SAE's J1772 protocol, Inter-Integrated Circuit (I2C), Serial Peripheral Interface (SPI), Controller Area Network (CAN), Universal Asynchronous Reception and Transmission (UART), Ethernet, or Universal Serial Bus (USB), or custom communications protocols. In some implementations, some or all of control modules 122-125 may also communicate wirelessly with EVs 131-134 using standard communications protocols, such as Bluetooth, WiFi, ZigBee, Z Wave, NEC Infrared (IR), Code Division Multiple Access (CDMA), Global System for Mobile Communications (GSM), or Long-Term Evolution (LTE), or custom communications protocols. In some implementations, some or all of control modules 122-125 may communicate wirelessly with EVs 131-134 instead of through a wired connection. In some implementations, control modules 121-125 may communicate with one another using a first communications protocol, and control modules 122-125 may communicate with EVs 131-134 using a second communications protocol different from the first communications protocol. In some implementations, control modules 121-125 may communicate with one another and with EVs 131-134 using the same communications protocol. As shown, each one of EVs 131-134 communicates with a different one of control modules 122-125. However, in other implementations, a single control module may communicate with two or more EVs.

As explained in Bart Basille, Level 1 and Level 2 Electric Vehicle Service Equipment (EVSE) Reference Design, Texas Instruments (2016), which is incorporated herein by reference, a J1772 compliant EVSE communicates with an EV with a pilot signal over a pilot line. The duty cycle of the pilot signal communicates the limit of current the EVSE is capable of supplying to the EV. Table 1 illustrates some examples of the current limits associated with particular duty cycles for level 1 and 2 AC charging units.

TABLE 1

| Duty Cycle | Current Limit |
|---|---|
| 8.3% | 5 A |
| 25% | 15 A |
| 50% | 30 A |
| 66.6% | 40 A |
| 90% | 65 A |
| 96% | 80 A |

A J1772 compliant EVSE cycles through various states during the connection and negotiation process with an EV. Table 2 summarizes these states.

TABLE 2

| | Pilot High | Pilot Low | | | | |
|---|---|---|---|---|---|---|
| State | Voltage | Voltage | Frequency | Resistance | | Description |
| A | 12 V | N/A | DC | N/A | | Not connected |
| B | 9 V | −12 V | 1 kHz | 2.74 | kΩ | EV connected &, |
| | | | | | | ready to charge |
| C | 6 V | −12 V | 1 kHz | 882 | Ω | EV charging |
| D | 3 V | −12 V | 1 kHz | 246 | Ω | EV charging & |
| | | | | | | ventilation |
| | | | | | | required |

| | | | | | |
|---|---|---|---|---|---|
| E | 0 V | 0 V | N/A | — | Error |
| F | N/A | −12 V | N/A | — | Unknown error |

As shown above, in State A, a J1772 compliant EVSE initially puts 12V on the pilot wire. When an EV is connected to the EVSE, the EV places a 2.74-k (2 load on the pilot line, which drops the voltage to 9V. In response, the EVSE moves to State B where it enables the PWM to communicate to the EV how much current it can draw. In response, the vehicle starts to draw power and switches to a 822-2 load, which drops the voltage to 6V and signals to the EVSE that charging has started. When the EV is disconnected from the EVSE, the voltage on the pilot wire returns to 12V, which causes the EVSE to return to State A. As noted above, in some implementations, control modules 122-125 may communicate with EVs 131-134, respectively, using SAE's J1772 protocol.

Control module 121 may communicate with server 170 through network 160. Server 170 may include one or more processors, one or more application specific integrated circuits (ASICs), and/or other similar components. Server 170 may also include a memory medium, such as a hard-drive, memory card, ROM, RAM, DVD, CD-ROM, write-capable, and/or read-only memory, that is capable of storing information. Network 160 may include wired and/or wireless segments and/or networks. For example, network 160 may include wireless networks that conform to an IEEE 802.11x standard (e.g., wireless local area networks (WLANs)) and/or cellular networks. As another example, network 160 may include private and/or public networks, metropolitan area networks (MANs), and/or wide area networks (WANs), such as the Internet.

Control module 121 and/or server 170 may control both the timing and/or the amount of power distributed to each of EVs 131-134. For example, in some implementations, control module 121 and/or server 170 may implement a schedule for delivering power to each of EVs 131-134. For example, EV 131 may be scheduled to receive 100% of P_{EV} every Monday from lam to 2 am, EV 132 may be scheduled to receive 100% of P_{EV} every Monday from 2 am to 3 am, EV 133 may be scheduled to receive 100% of P_{EV} every Monday from 3 am to 4 am, and EV 134 may be scheduled to receive 100% of P_{EV} every Monday from 4 am to 5 am. As another example, zone 102 may be scheduled to receive 80% of P_{EV} every Tuesday from 2 am to 4 am, and zone 103 may be scheduled to receive 20% of P_{EV} during those hours. As yet another example, zone 102 may be scheduled to receive 0% of P_{EV} every Wednesday from 2 am to 4 am, and zone 103 may be scheduled to receive 100% of P_{EV} during those hours. In some such implementations, the amount of power distributed to each zone may be shared equally by the EVs in that zone. In other implementations, one or more EVs in a particular zone may be prioritized over other EVs in that zone. In some implementations, control module 121 and/or server 170 may prioritize the charging of a subset of EVs 131-134. In some such implementations, the owner(s) of the prioritized EV(s) may pay an additional fee for this benefit.

Control module 121 and/or server 170 may also record the amount of power consumed by each of EVs 131-134 during a particular time period (e.g., for prediction and/or billing purposes). In some such implementations, control modules 122-125 may communicate wirelessly and through a wired connection with EVs 131-134, respectively. For example, control modules 122-125 may use a wired connection (e.g., a pilot line of a J1772 connector) to communicate how much current EVs 131-134, respectively, can draw. Furthermore, control modules 122-125 may communicate wirelessly (e.g., through Radio Frequency Identification (RFID)) with EVs 131-134, respectively, to identify each of EVs 131-134 for reporting, billing, and/or scheduling purposes. In other implementations, the same communications protocol may be used to both identify an EV and communicate how much current the EV can draw.

After recording the power consumption information for EVs 131-134, control modules 122-125 may forward the information to control module 121, which may then forward the information to server 170. In some implementations, a user can access this information through an external device (not shown) that communicates with control module 121 and/or server 170 through network 160. For example, control module 121 and/or server 170 may be configured to send the external device power consumption information for one or more of EVs 131-134 in response to a request. In some implementations, a user can request a report detailing when and how much power was consumed by each of EVs 131-134 during a particular time period. In some implementations, a user can request real-time status information indicating, for example, how many EVs are currently connected to system 100. In some implementations, a user may be able to modify billing and/or scheduling parameters for one or more of EVs 131-134 by sending a request with an external device (not shown) to control module 121 and/or server 170. In some implementations, control module 121 and/or server 170 may include a server application programming interface (SAPI) for expanding or integrating into other systems, such as billing systems or systems for forecasting and planning for future building needs.

In some implementations, electrical panels 111-113 and control modules 121-125 may collectively provide level 1 and/or 2 charging to EVs 131-134. Level 1 and 2 charging units typically cost less than level 3 charging units. Furthermore, a level 2 charging unit can be configured to provide level 1 charging. Therefore, in some implementations (e.g., in a multi-unit residential building), it may be advantageous to design electrical panels 111-113 and control modules 121-125 to provide both level 1 and 2 charging depending on the current value of P_{EV}. However, in some implementations, electrical panels 111-113 and control modules 121-125 may collectively provide level 3 charging to EVs 131-134.

As shown, system 100 is only capable of charging four EVs. However, system 100 can be expanded to support many more EVs. For example, system 100 can be expanded to include three or more electrical subpanels, each of which is capable of charging a plurality of EVs. In some such implementations, additional intermediary electrical panels and/or control modules may be added to system 100. For example, electrical panel 111 may distribute power to an intermediary electrical panel that then distributes the power to electrical panels 112 and 113. Similarly, control module 121 may communicate with an intermediary control module that then communicates with control modules 122-125. System 100 can also be scaled down (e.g., for a single-family home). In some such examples, the functionality of electrical panels 111-112 and/or control modules 121-125 may be integrated into a fewer number of components (e.g., a single electrical panel and one or two control modules).

In some implementations, system 100 can provide a flexible and scalable solution to the challenges of adding EV battery-charging units to multi-unit residential buildings. Since each building is built with its own power capacity and electrical specifications (dependent on multiple variables), system 100 can be configured to understand those constraints and operate within them. For example, as explained above, system 100 may be configured to increase or decrease the amount of power available to EVs 131-134 based on the power currently being drawn by prioritized load 150. By operating within the existing electrical specifications, a permit may not even be necessary to install portions of system 100 in a multi-unit residential building. Furthermore, system 100 can be easily expanded over time. As more residents need chargers for their EVs, additional zones, control modules, and/or electrical subpanels can be added to system 100. By monitoring the overall power consumption of the prioritized load and the EVs, system 100 can redistribute power to stay within the existing electrical specifications. In some implementations, system 100 can be used to predict electrical needs based on the recorded power consumption of connected EVs. In some implementations, system 100 can be deployed across a plurality of multi-unit residential buildings. In some such implementations, system 100 may be configured to separately monitor the prioritized load of each building.

In some implementations, system 100 can provide a relatively low-cost solution to the challenges of adding EV battery-charging units to multi-unit residential buildings or even single-family homes. As already noted above, by operating within the existing electrical specifications, a permit may not even be necessary to install portions of system 100. Furthermore, portions of system 100 can be installed without disrupting pre-existing systems. For example, zone 104 may represent the components of a preexisting system. Before the installation of the components in zones 101-103, electrical panel 114 may be a main electrical panel that receives power directly from electrical grid 140 and then distributes the power to prioritized load 150. Without modifying power distribution lines 146, electrical panel 114 may be installed such that it can monitor the power distributed to prioritized load 150 through electrical panel 114. New power distribution lines (e.g., power distribution lines 141) can then be run from electrical panel 111 to electrical panels 112 and 113. Therefore, in such implementations, the components of zones 101-103 can simply be added to a preexisting system (e.g., the components zone 104) without significantly altering any of the components of the preexisting system.

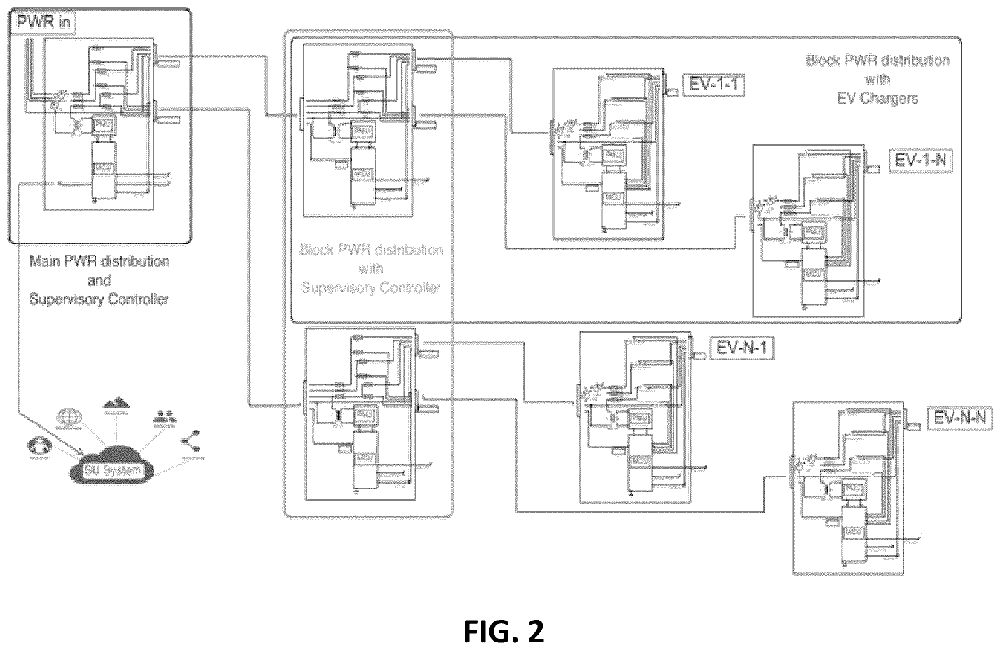

FIGS. 2-8 illustrate circuits that may be incorporated into system 100 of FIG. 1. For example, FIG. 2 illustrates a circuit of interconnected modules in communication with one or more servers (i.e., “SU System”). As shown, the circuit includes a main power distribution and supervisory control module, two block power distribution and supervisory control modules, and four charging modules. The main power distribution and supervisory control module receives power (i.e., “PWR in”) from a power source, such as an electrical grid, and distributes it to the charging modules via the block power distribution and supervisory control modules. The charging modules then provide the available power to any connected EVs (see “EV-1-1,” “EV-1-N,” “EV-N-1,” and “EV-N-N,”). The main power distribution and supervisory control module may be compared to electrical panel 111 and control module 121 in zone 101 of FIG. 1. As such, the main power distribution and supervisory control module may provide some or all of the functionality described above in relation to electrical panel 111 and control module 121. The charging modules may be compared to electrical panels 112 and 113 and control modules 122-125 in zones 102 and 103 of FIG. 1. As such, the charging modules may provide some or all of the functionality described above in relation to electrical panels 112 and 113 and control modules 122-125. The one or more servers may be compared to server 170 of FIG. 1. As such, the one or more servers may provide some or all of the functionality described above in relation to server 170.

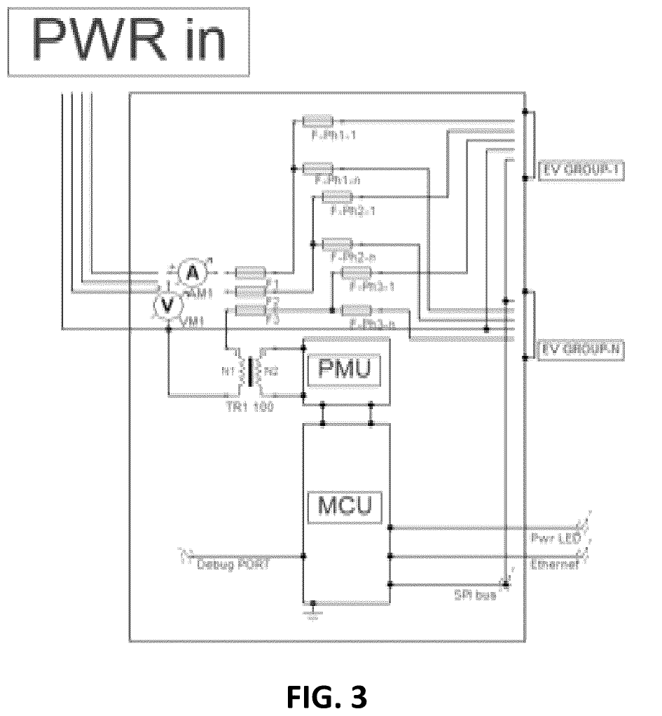

FIG. 3 illustrates the main power distribution and supervisory control module of FIG. 2 in greater detail. As shown, the circuit includes a plurality of fuses, a transformer (i.e., “TR1”), a phasor measurement unit (PMU), and a controller (i.e., “MCU”). The PMU may be configured to measure the received power (i.e., “PWR in”). The controller may receive and/or process the measurements obtained by the PMU. The controller may also communicate with a server (e.g., the one or more servers of FIG. 2) and/or one or more other controllers. As shown the controller includes an Ethernet and an SPI interface. In some implementations, the controller may include additional and/or different communications interfaces.

In some implementations, the controller of FIG. 3 may be responsible for ensuring that a power load (e.g., a plurality of EVs and a residential load) never exceeds a predetermined threshold (e.g., a load capacity or current limit of a building). In some such implementations, the amount of power available for EV charging may be calculated using the following equations:

I_{EV}=I_{GRID}−I_{RES},

P_{EV}=P_{GRID}−P_{RES},

P_{EV}=V_{GRID}(I_{GRID}−I_{RES}),

where I_{EV} is the total current available for EV charging, I_{GRID} is the total current that can be drawn by the EVs and a residential load (e.g., the total power that can be drawn by a multi-unit residential building), and I_{RES} is the total current currently being drawn by the residential load, P_{EV} is the total power that can be drawn by the EVs, P_{GRID} is the maximum power that can be drawn by the EVs and the residential load, P_{RES} is the total power currently being drawn by the residential load, and V_{GRID} is the voltage of the system (e.g., 240V). In some implementations, V_{GRID} and/or I_{GRID} may be predetermined values. In some implementations, V_{GRID}, I_{GRID}, and/or I_{RES} may be measured in real-time to calculate P_{EV}.

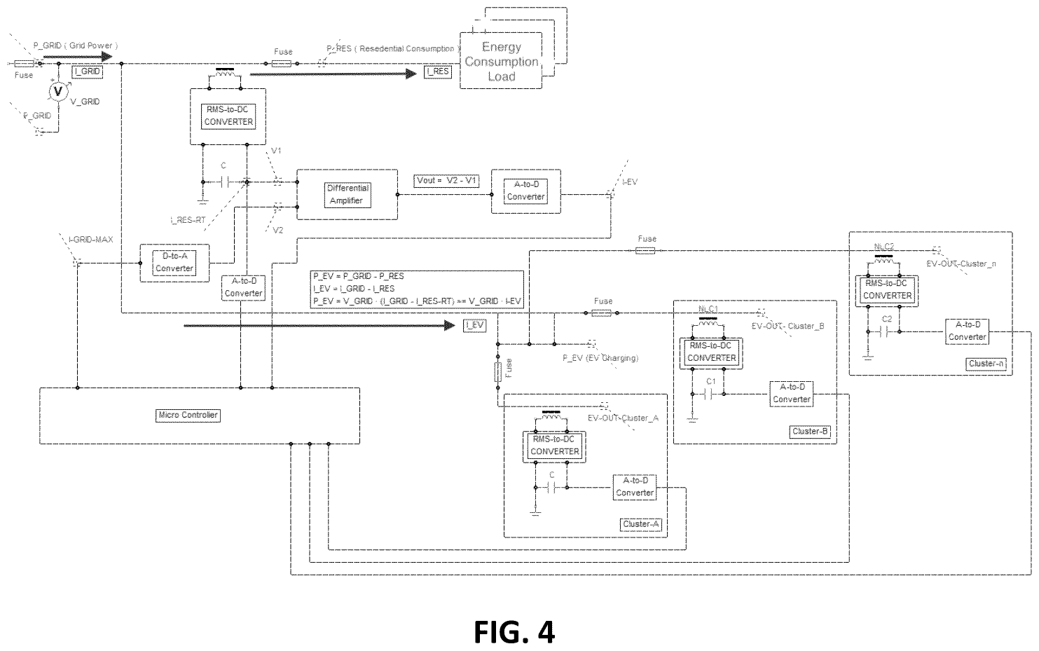

FIG. 4 illustrates aspects of the circuit of FIG. 2 in greater detail that relate to the calculation of P_{EV}. As shown, the circuit includes a plurality of fuses, a plurality of capacitors, a plurality of RMS to DC converters, a plurality of analogue to digital converters, a digital to analogue converter, a differential amplifier, an energy consumption load, and a controller. The energy consumption load may be compared to the prioritized load 150 of FIG. 1. The controller may be compared to the controller of FIG. 3 (i.e., “MCU”). In some implementations, some of the components illustrated in FIG. 4 may be incorporated into the main power distribution and supervisory control module of FIG. 2 and some of the components illustrated in FIG. 4 may be incorporated into one or more of the charging modules of FIG. 2. For example, the capacitor, the RMS to DC converter, and the analogue to digital converter in the dashed box labeled “Cluster A” may be incorporated into one of the charging modules of FIG. 2. Similarly, the capacitor, the RMS to DC converter, and the analogue to digital converter in the dashed box labeled “Cluster B” may be incorporated into another one of the charging modules of FIG. 2. Many of the remaining components outside the dashed boxes labeled “Cluster A,” “Cluster B,” and “Cluster n,” may be incorporated into the main power distribution and supervisory control module of FIG. 2.

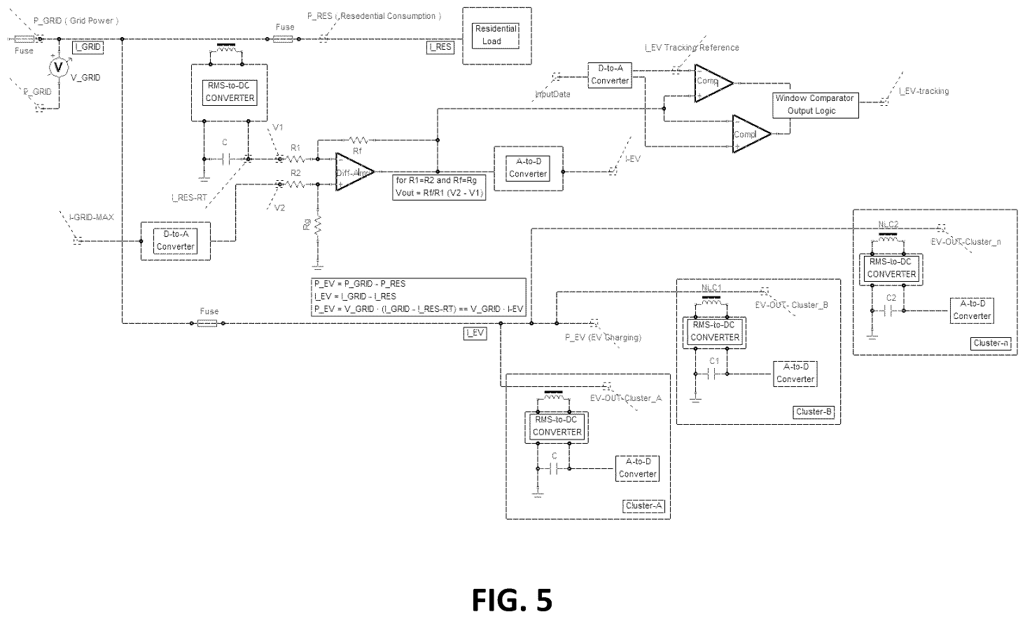

As shown in FIG. 4, power is allocated such that P_{RES} is measured and subtracted from P_{GRID} via the differential amplifier (e.g., an INA169 as disclosed in Texas Instruments, INA1x9 High-Side Measurement Current Shunt Monitor (2017), which is incorporated herein by reference). More specifically, an I_{GRID} value is provided into positive input of the differential amplifier and an I_{RES} value is provided into negative input. These currents may be converted into voltages by resistors (e.g., R₁, R₂, R_{g}, and/or Rr or FIG. 5). As shown in the equations above, the difference between I_{GRID} and I_{RES} can be used to calculate P_{EV}. The I_{GRID} value may be supplied by the controller via the digital to analogue converter. The I_{RES} value may be supplied by one of the RMS to DC converters. In other implementations, the functionality of the differential amplifier may be incorporated into the controller or another separate controller. For example, the I_{RES} value can be provided directly to the controller. In some such implementations, the controller may compare digital values of I_{GRID} and I_{RES}, rather than analogue values. In some implementations, the measurement resolution may be a minimum EV charge-current-allocation (e.g., 6 A).

In FIG. 4, current is measured using RMS to DC converters in combination with analogue to digital converters. However, current can be measured in number of ways, such as with a current transformer, a Rogowski Coil, a shunt resistor, or a Hall effect current sensor. For example, a Hall effect sensor can be used to measure the magnetic field generated by the current flow in a conductor. These sensors can be calibrated to provide a proportional output voltage or current that represents the measured current. Some models of Hall effect sensors are even capable of measuring currents up to 2000 A or more. Therefore, Hall effect sensors are particularly well suited for the systems disclosed herein. As shown, an output of each RMS to DC converter is coupled to an input of an analogue to digital converter in communication with the controller. In some implementations, the signals received from the RMS to DC converter configured to measure the current drawn by the energy consumption load may be used by the controller to determine an amount of power available for EV charging. In some implementations, the signals received from the RMS to DC converters in “Cluster A,” “Cluster B,” and “Cluster n” may be used by the controller to, for example, dynamically adjust I_{GRID}, dynamically adjust the amount of power distributed to each of a plurality of charging modules, generate an alert, and/or control one or more switches (not shown). For example, the controller may be configured to redistribute power allocations in response to a detection the one or more EVs have finished charging or have been disconnected. As another example, an alert may be generated when a total power drawn by all connected EVs is above or below a predetermined threshold (e.g., P_{GRID}). As yet another example, the controller may be configured to automatically disconnect one or more EVs when a total power drawn by all connected EVs is above or below a predetermined threshold (e.g., P_{GRID})).

FIG. 5 illustrates a modified version of the circuit of FIG. 4 that further includes a mechanism for generating an alert when there is a significant change in the system that may affect how power is distributed to the EVs. The additional components include another digital to analogue converter and a plurality of comparators. The input data for the digital to analogue converter may be supplied by the controller of FIG. 4. As shown in FIG. 4, the components in “Cluster A,” “Cluster B,” and “Cluster n,” may provide current and/or power measurements to the controller that are, for example, used to generate the input data for the digital to analogue converter. The additional digital to analogue converter of FIG. 5 may then provide one or more adjustable threshold voltages to the plurality of comparators (e.g., a voltage threshold corresponding to a maximum value and a voltage threshold corresponding to a minimum value). By combining two comparators in the manner shown in FIG. 5, a window comparison is formed where, when an input voltage (e.g., Vout from the differential amplifier) goes above a maximum threshold or below a minimum threshold, the combined output of the plurality of comparators provides a warning indication. By utilizing adjustable thresholds, the window comparator of FIG. 5 is dynamic and allows the system to automatically adjust in response to different conditions.

In some implementations, the individual outputs of the plurality of comparators and/or a combined output may be provided to one or more inputs, such as an interrupt-input, of the controller of FIG. 4. In some such implementations, if there is a sudden increase or decrease in the amount of EVs connected to the system, a warning signal may be generated. In response, the controller of FIG. 4 may adjust and/or redistribute power to different charging modules. In some implementations, the individual outputs of the plurality of comparators and/or a combined output may be provided to another separate controller in communication with the controller of FIG. 4 or other analog circuitry configured to trigger corrective actions, such as adjusting total available current used by suspending/delaying charging activities, decreasing/increasing charge current of one or more EVs, and/or re-prioritizing charging. In some implementations, circuitry, such as an RC circuit, may be inserted between the outputs of the plurality of comparators and the controller of FIG. 4 and/or other circuitry to smoothen the individual outputs of the plurality of comparators and/or a combined output. In some implementations, some or all of the functionality of the additional circuitry of FIG. 5 may be incorporated into the controller of FIG. 4 or another separate controller in communication with the controller of FIG. 4.

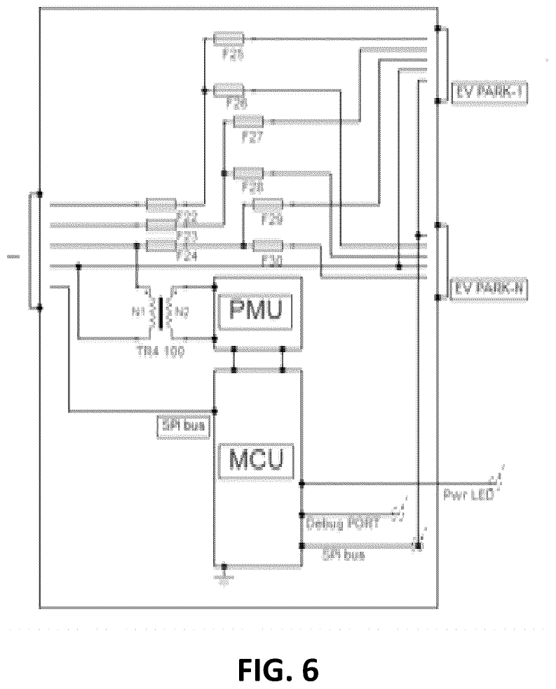

FIG. 6 illustrates one of the block power distribution and supervisory control modules of FIG. 2 in greater detail. As shown, it is very similar to the main power distribution and supervisory control module of FIG. 3. It includes a plurality of fuses, a transformer (i.e., “TR4”), a phasor measurement unit (PMU), and a controller (i.e., “MCU”). The PMU may be configured to measure the received power. The controller may receive and/or process the measurements obtained by the PMU. The controller may also communicate with the controller of FIG. 3 and/or one or more other controllers in, for example, other block power distribution and supervisory control modules and/or other charging modules. As shown the controller includes an Ethernet and an SPI interface. In some implementations, the controller may include additional and/or different communications interfaces.

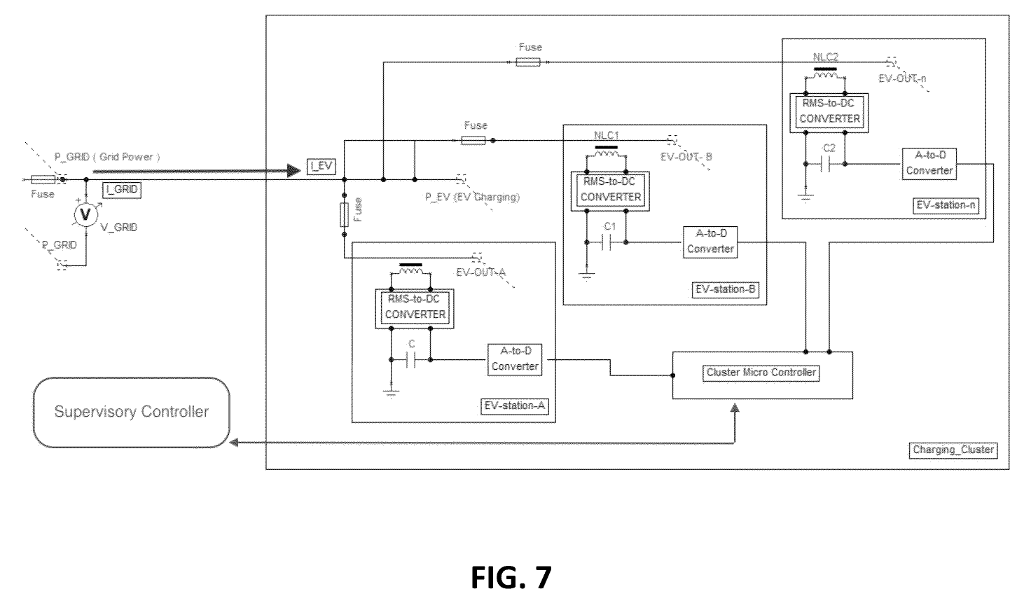

Block power distribution and supervisory control modules, such as the one illustrated in FIG. 6, may be particularly useful in larger multi-unit residential buildings. These modules can act as an extension to a main power distribution and supervisory control module, such as the one illustrated in FIG. 3. For example, a main power distribution and supervisory control module can offload some of the tasks relating to monitoring and/or distributing power to a block power distribution and supervisory control module. An example of this is illustrated in FIG. 7 where the “Cluster Micro Controller” corresponds to the controller of FIG. 6 and the “Supervisory Controller” corresponds to the controller of FIG. 3. Much like a main power distribution and supervisory control module, a block power distribution and supervisory control module can also protect upstream and downstream power by, for example, communicating appropriate power limits to connected EVs (e.g., how much current the EVs can draw).

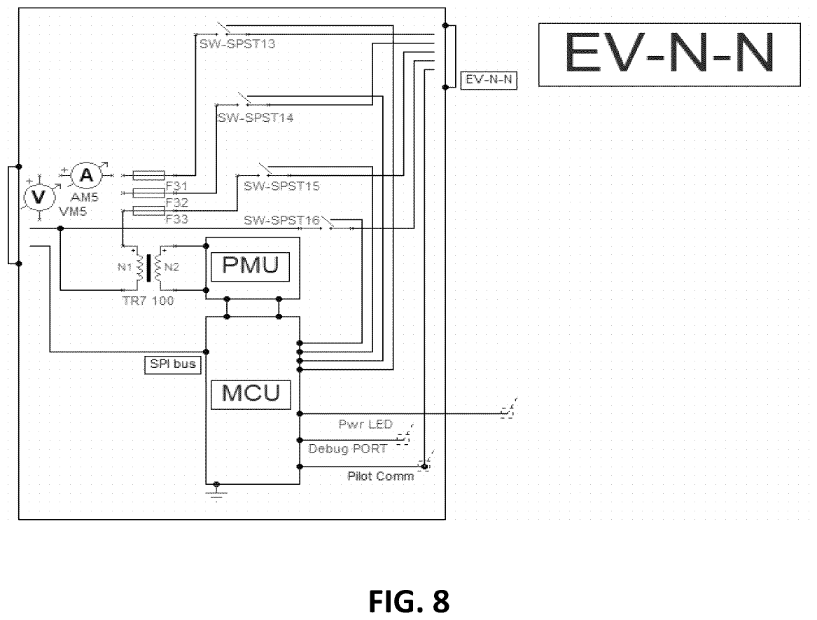

FIG. 8 illustrates one of the charging modules of FIG. 2 in greater detail. As shown, the circuit includes a plurality of fuses, a plurality of single pole single throw (SPST) switches, a transformer (i.e., “TR7”), a phasor measurement unit (PMU), and a controller (i.e., “MCU”). The SPST switches are controlled by the controller. In some implementations, one or more of the SPST switches may be combined and/or replaced with other types of switches, such as single pole double throw (SPDT) switches and/or double pole double throw (DPDT) switches. The PMU may be configured to measure the received power. The controller may receive and/or process the measurements obtained by the PMU. The controller may also communicate with the controller of FIG. 3, the controller of FIG. 6, and/or one or more other controllers in, for example, other block power distribution and supervisory control modules and/or other charging modules. As shown the controller includes an SPI interface and a pilot line. In some implementations, the controller may include additional and/or different communications interfaces. For example, the controller may include a Radio Frequency Identification (RFID) interface for identifying a connected EV.

The charging module of FIG. 8 can provide a power limit to a connected EV via the pilot line. For example, based on information received from a main power distribution and supervisory control module and/or a block power distribution and supervisory control module, the charging module can adjust the duty cycle of a PWM signal transmitted through the pilot line. The charging module can also disconnect a connected EV from the power grid by opening all of the SPST switches. In some implementations, the SPST switches may be opened to enable the charging module to return to State A. Once in State A, the SPST switches may be closed again and the charging module may renegotiate the amount of power that the connected EV can draw by cycling through States B and C. As a result, the charging module can dynamically increase or decrease the amount of power than can be drawn by a connected EV while, for example, still remaining J1772 compliant.

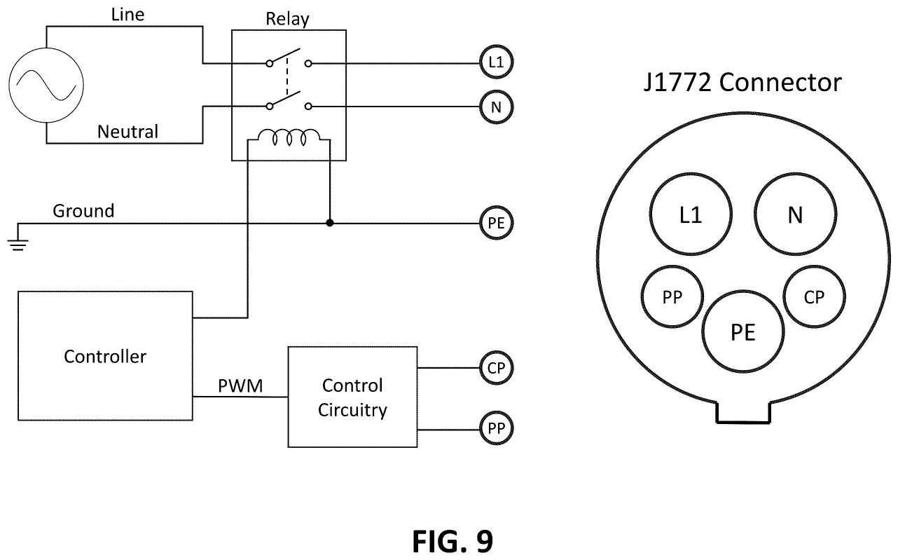

FIG. 9 illustrates a circuit diagram for a single-phase electric vehicle service equipment (EVSE) with a J1772 connector. As shown, the J1772 connector has a line 1 (L1) pin, a neutral (N) pin, a protective earth (PE) pin, a control pilot (CP) pin, and a proximity pilot (PP) pin. The PE pin is coupled to ground. The L1 and N pins are coupled to a single-phase AC power source through a relay. The controller illustrated in FIG. 9 may control the relay to open or close. The controller may also transmit a PWM signal to control circuitry, which is coupled to the CP and PP pins of the J1772 connector. As explained above, the PWM signal may be used to communicate to an EV how much current it can draw (e.g., by adjusting the duty cycle).

As explained in Surya Mishra, L1 and L2 EV Charger Electric Vehicle Service Equipment Design Considerations, Texas Instruments (2021) and Kelvin Le et al., AC Level 2 Charger Platform Reference Design, Texas Instruments (2022), which are incorporated herein by reference, the circuit of FIG. 9 may include additional components, such as energy metering circuitry, AC and DC residual current detection circuitry, and/or an isolation monitor unit. Some of these additional components may provide feedback to the controller to determine when it opens or closes the relay. For example, when the measured voltage and/or current that would be delivered to the L1 and N pins is above or below a predetermined threshold, the controller may automatically open the relay to avoid risks like battery damage, electrical shorts, or fires.

In some implementations, the circuit of FIG. 9 may be incorporated into system 100 of FIG. 1. In such implementations, the wires coupled to the L1, N, and PE pins may be compared to power distribution lines 142-145. Similarly, the wires coupled to the CP and PP pins may be compared to communication lines 162-165. Furthermore, the controller of FIG. 9 may be compared to control modules 122-125. In some such implementations, the relay and/or the control circuitry of FIG. 9 may be incorporated into electrical panel 112 and/or 113.

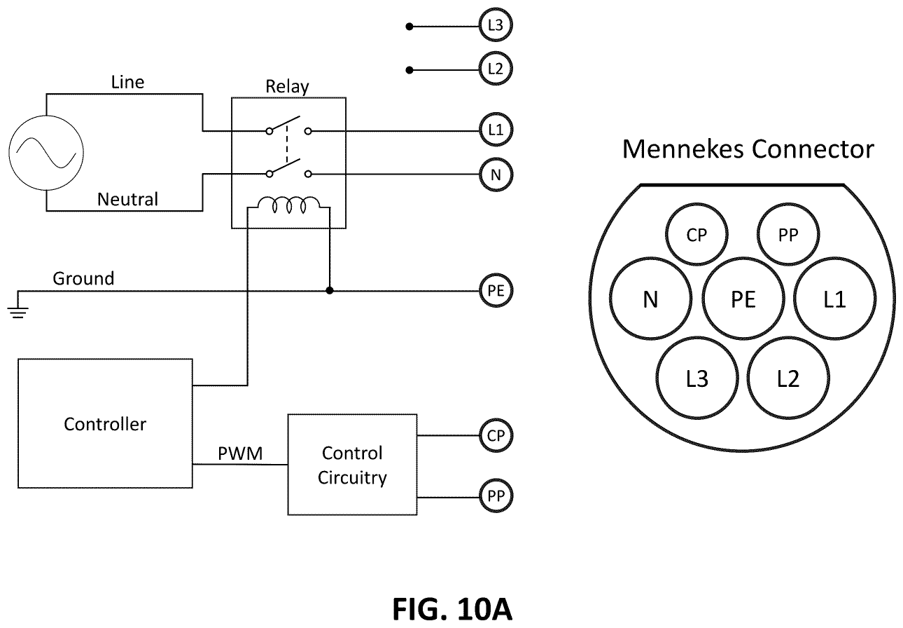

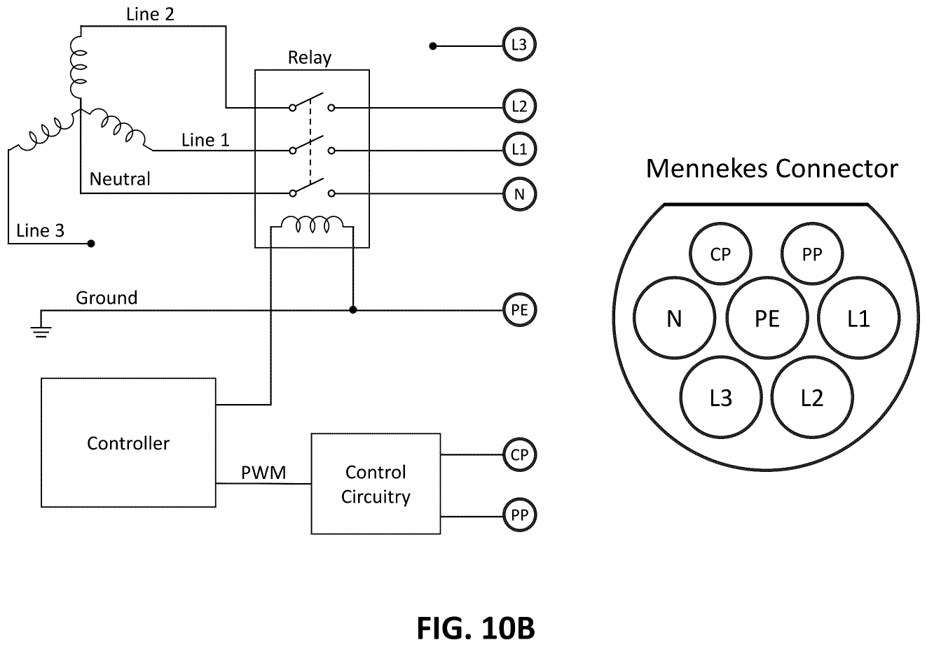

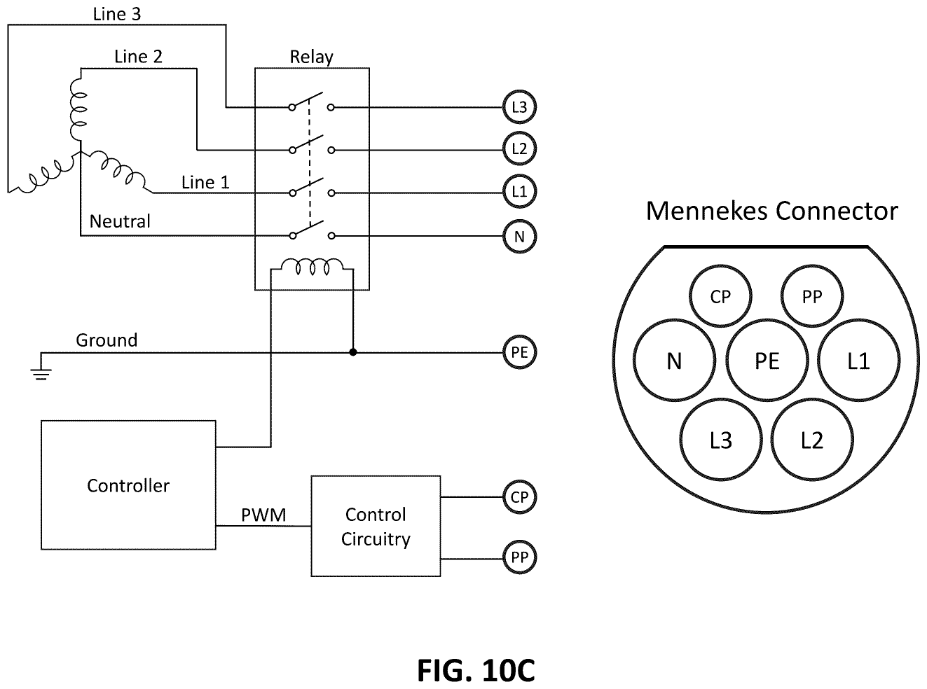

FIG. 10A illustrates a circuit diagram for a single-phase EVSE with a Mennekes connector. As shown, the Mennekes connector has a line 1 (L1) pin, a line 2 (L2) pin, a line 3 (L3) pin, a neutral (N) pin, a protective earth (PE) pin, a control pilot (CP) pin, and a proximity pilot (PP) pin. Since the L2 and L3 pins are not being used, the circuit of FIG. 10A is identical to the circuit of FIG. 9. Therefore, the components shown operate in the same way, the circuit may be similarly modified to include additional components, and the circuit of FIG. 10A may be similarly incorporated into system 100 of FIG. 1.

FIG. 10B illustrates a circuit diagram for a two-phase EVSE with a Mennekes connector. The circuit of FIG. 10B is very similar to the circuit of FIG. 10A. However, the single-phase AC power source of FIG. 10A has been replaced with a three-phase AC power source in FIG. 10B. Furthermore, the double-pole, single-throw (DPST) relay of FIG. 10A has been replaced with a three-pole, single-throw (3PST) relay in FIG. 10B, and the L2 pin has been connected to the additional output of the 3PST relay. Despite these differences, the circuit of FIG. 10B operates in much the same way as the circuit of FIG. 10A, it may be similarly modified, and it may be similarly incorporated into system 100 of FIG. 1.

As shown in FIG. 10B, the neutral line, line 1, and line 2 of the three-phase AC power source are connected to the three inputs of the 3PST relay. However, the neutral line may be paired with any two of lines 1-3. For example, in another implementation, the neutral line, line 1, and line 3 of the three-phase AC power source may be connected to the three inputs of the 3PST relay. As another example, in another implementation, the neutral line, line 2, and line 3 of the three-phase AC power source may be connected to the three inputs of the 3PST relay. In other implementations, the three-phase AC power source may also be replaced with a two-phase AC power source. Similarly, the three-phase AC power source may be replaced with an AC power source with more phases. In such implementations, much like line 3 of FIG. 10B, the additional lines of such power sources may simply be unused.

As shown in FIG. 10B, the three-phase AC power source has a wye (Y) configuration. However, in other implementations, the three-phase AC power source may have a different configuration. For example, the three-phase AC power source may have a high-leg delta configuration. Both the wye configuration and the high-leg delta configuration are commonly used in the United States and Canada for commercial electrical service connections.

FIG. 10C illustrates a circuit diagram for a three-phase EVSE with a Mennekes connector. The circuit of FIG. 10C is very similar to the circuit of FIG. 10B. However, the 3PST relay of FIG. 10B has been replaced with a four-pole, single-throw (4PST) relay in FIG. 10C, and the L3 pin has been connected to the additional output of the 4PST relay. Despite these differences, the circuit of FIG. 10C operates in much the same way as the circuit of FIG. 10B, it may be similarly modified, and it may be similarly incorporated into system 100 of FIG. 1.

While the J1772 and Mennekes connectors are currently two of the most common types of connectors used for charging EVs, there are also a variety of other types of connectors that may be used, such as a GB/T connector, a Combined Charging System (CCS) connector, a CHAdeMO connector, or a Tesla connector. Depending on the number of necessary phases, one skilled in the art will readily appreciate that the circuits of FIGS. 9-10C may be easily adapted to work with one of these other types of connectors.

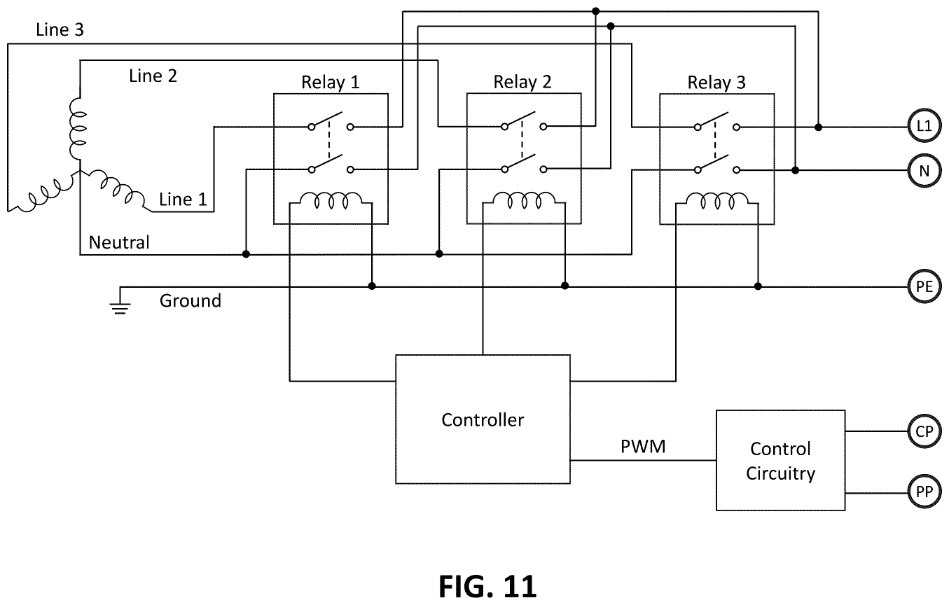

FIG. 11 illustrates a circuit for switching which lines power a single-phase, level 1 EVSE. The circuit of FIG. 11 can replace, for example, either of the circuits illustrated in FIGS. 9 and 10A. As shown, the circuit of FIG. 11 includes a three-phase AC power source with a neutral line and lines 1-3. The circuit also includes relays 1-3, each of which may be opened or closed by a controller. The controller can control these relays such that they are simultaneously in an open state or simultaneously in a closed state to provide similar functionality to the single relay in the circuits of FIGS. 9 and 10A. However, the controller may also control relays 1-3 to switch which lines of the three-phase AC power source are connected to the L1 and N pins (e.g., of a J1772 connector or a Mennekes connector). For example, the controller may close relay 1 and open relays 2 and 3, so that the L1 and N pins are coupled to the line 1 and neutral lines, respectively, of the three-phase AC power source. As another example, the controller may close relay 2 and open relays 1 and 3, so that the L1 and N pins are coupled to the line 2 and neutral lines, respectively, of the three-phase AC power source. As yet another example, the controller may close relay 3 and open relays 1 and 2, so that the L1 and N pins are coupled to the line 3 and neutral lines, respectively, of the three-phase AC power source.

Aside from the distinctions above, the circuit of FIG. 11 may be configured in much the same way as the circuits of FIGS. 9 and 10A. For example, the controller can transmit a PWM signal to control circuitry, which is coupled to the CP and PP pins (e.g., of a J1772 connector or a Mennekes connector). As explained above, the PWM signal can be used to communicate to an EV how much current it can draw (e.g., by adjusting the duty cycle). As another example, the circuit of FIG. 11 may include additional components, such as energy metering circuitry, AC and DC residual current detection circuitry, and/or an isolation monitor unit. Some of these additional components may provide feedback to the controller to determine when it opens or closes relays 1-3. For example, when the measured voltage and/or current that would be delivered to the L1 and N pins is above or below a predetermined threshold, the controller may automatically open all of relays 1-3 to avoid risks like battery damage, electrical shorts, or fires.

In some implementations, the circuit of FIG. 11 may be incorporated into system 100 of FIG. 1. In such implementations, the wires coupled to the L1, N, and PE pins may be compared to power distribution lines 142-145. Similarly, the wires coupled to the CP and PP pins may be compared to communication lines 162-165. Furthermore, the controller of FIG. 11 may be compared to control modules 122-125. In some such implementations, relays 1-3 and/or the control circuitry of FIG. 11 may be incorporated into electrical panel 112 and/or 113.

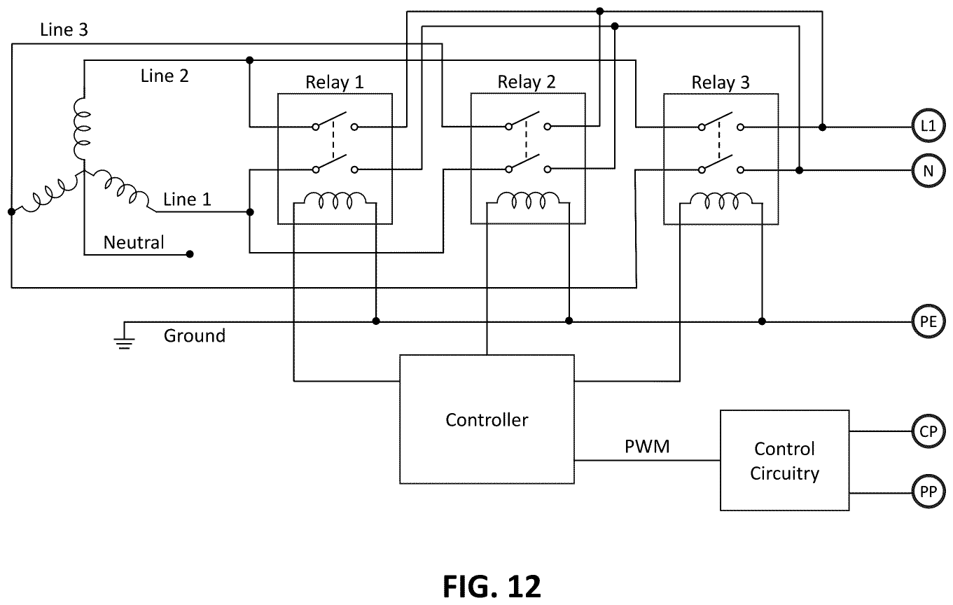

FIG. 12 illustrates a circuit for switching which lines power a single-phase, level 2 EVSE. The circuit of FIG. 12 is very similar to the circuit of FIG. 11. However, in order to provide level 2 charging, the neutral line of the three-phase AC power source is unused. Instead, through the use of relays 1-3, different pairings of lines 1-3 are coupled to the L1 and N pins. For example, the controller may close relay 1 and open relays 2 and 3, so that the L1 and N pins are coupled to lines 2 and 1, respectively, of the three-phase AC power source. As another example, the controller may close relay 2 and open relays 1 and 3, so that the L1 and N pins are coupled to lines 3 and 1, respectively, of the three-phase AC power source. As yet another example, the controller may close relay 3 and open relays 1 and 2, so that the L1 and N pins are coupled to lines 2 and 3, respectively, of the three-phase AC power source. Aside from these differences, the circuit of FIG. 12 operates in much the same way as the circuit of FIG. 11, it may be similarly modified, and it may be similarly incorporated into system 100 of FIG. 1.

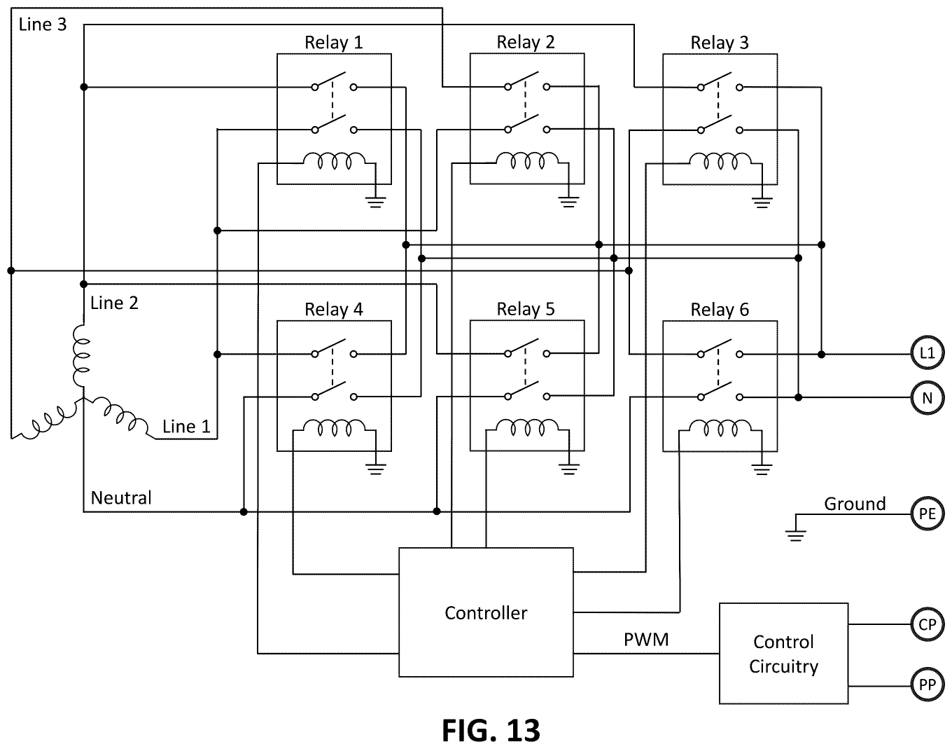

FIG. 13 illustrates a circuit for switching the lines and/or power level of a single-phase EVSE. The circuit of FIG. 13 essentially combines the circuits of FIGS. 11 and 12 to provide cither level 1 or level 2 charging. In this implementation, relays 1-3 may be used to provide level 2 charging and relays 4-6 can be used to provide level 1 charging. For example, the controller can close relay 1 and open relays 2-6, so that the L1 and N pins are coupled to lines 2 and 1, respectively, of the three-phase AC power source. As another example, the controller may close relay 2 and open relays 1 and 3-6, so that the L1 and N pins are coupled to lines 3 and 1, respectively, of the three-phase AC power source. As yet another example, the controller can close relay 3 and open relays 1, 2, and 4-6, so that the L1 and N pins are coupled to lines 2 and 3, respectively, of the three-phase AC power source. As yet another example, the controller can close relay 4 and open relays 1-3, 5, and 6, so that the L1 and N pins are coupled to the line 1 and neutral lines, respectively, of the three-phase AC power source. As yet another example, the controller may close relay 5 and open relays 1-4 and 6, so that the L1 and N pins are coupled to the line 2 and neutral lines, respectively, of the three-phase AC power source. As yet another example, the controller can close relay 6 and open relays 1-5, so that the L1 and N pins are coupled to the line 3 and neutral lines, respectively, of the three-phase AC power source. Aside from these differences, the circuit of FIG. 13 operates in much the same way as the circuits of FIGS. 11 and 12, it may be similarly modified, and it may be similarly incorporated into system 100 of FIG. 1.

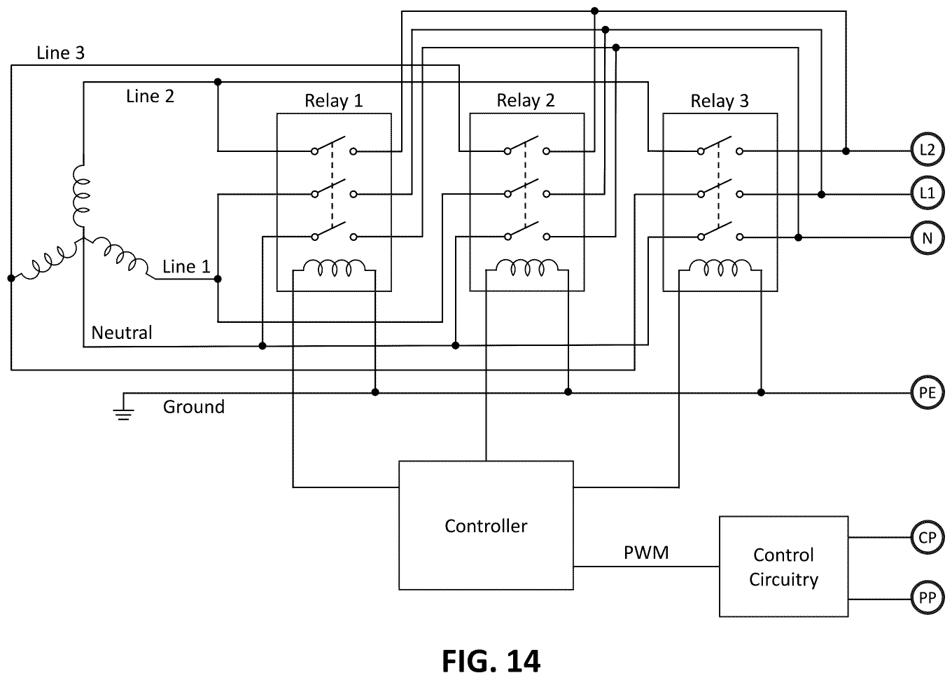

FIG. 14 illustrates a circuit for switching which lines power a two-phase, level 2 EVSE. The circuit of FIG. 14 is very similar to the circuit of FIG. 12. However, in order to provide two-phase power to an EV, the DPST relays of FIG. 12 have been replaced with 3PST relays in FIG. 14. As a result, the neutral line of the three-phase AC power source may be paired with any two of lines 1-3. For example, the controller may close relay 1 and open relays 2 and 3, so that the L2, L1, and N pins are coupled to line 2, line 1, and the neutral line, respectively, of the three-phase AC power source. As another example, the controller may close relay 2 and open relays 1 and 3, so that the L2, L1, and N pins are coupled to line 3, line 1, and the neutral line, respectively, of the three-phase AC power source. As yet another example, the controller can close relay 3 and open relays 1 and 2, so that the L2, L1, and N pins are coupled to line 2, line 3, and the neutral line, respectively, of the three-phase AC power source. Aside from these differences, the circuit of FIG. 14 operates in much the same way as the circuit of FIG. 12, it may be similarly modified, and it may be similarly incorporated into system 100 of FIG. 1.

In some implementations, the circuits of any one of FIGS. 10C-13 may be combined with the circuit of FIG. 14. Unlike a type 1 connector (e.g., a J1772 connector), a type 2 connector (e.g., a Mennekes connector) can deliver more than one phase of power to an EV. As a result, an EV with a type 2 connector may automatically detect the available phases (e.g., single-phase, two-phase, or three-phase) and adjust its operation accordingly. By combining the circuits of any one of FIGS. 10C-13 with the circuit of FIG. 14, the number of phases of power delivered to an EV can be adjusted. For example, by combining the circuits of any one of FIGS. 11-13 with the circuit of FIG. 14, single-phase or two-phase power may be delivered to an EV. As another example, by combining the circuit of FIG. 10A with the circuit of FIG. 14, two-phase or three-phase power may be delivered to an EV. As yet another example, by combining (a) any one of FIGS. 11-13 and (b) the circuit of FIG. 10A with the circuit of FIG. 14, single-phase, two-phase, or three-phase power may be delivered to an EV.

Various modifications can be made to any of the circuits described above in relation to FIGS. 9-14. For example, the three-phase AC power source of any one of FIGS. 10B-14 may have a different configuration (e.g., a high-leg delta configuration instead of a wye configuration). As another example, the three-phase AC power source of any one of FIGS. 10B-14 may be replaced with an AC power source with more phases. In some such implementations, a circuit may even be configured to selectively deliver more than three phases of power to an EV.

As yet another example, the type, number, and/or configuration of the relays of FIGS. 9-14 may be changed, but still provide comparable functionality. For example, the DPST relays of FIG. 11 may be replaced with single-pole, single-throw (SPST) relays. In such implementations, the SPST relays may, for example, be used to selectively couple one of lines 1-3 to the L1 pin, and the neutral line may be permanently coupled to the N pin. Similarly, the 3PST relays of FIG. 14 may be replaced with DPST relays. In such implementations, the DPST relays may, for example, be used to selectively couple two of lines 1-3 to the L1 and L2 pins, and the neutral line may be permanently coupled to the N pin. As another example, one or more additional relays may be added to any one of the circuits of FIGS. 11-14. For example, a relay may be specifically added for avoiding risks like battery damage, electrical shorts, or fires (e.g., the relays of FIGS. 9-10C) and other relays (e.g., the relays of FIGS. 11-14) may be used specifically for switching (a) which lines of an AC power source are connected to an EV, (b) what level of charging is provided (e.g., level 1 or level 2) to an EV, and/or (c) the number of phases of power delivered to an EV. As yet another example, one or more relays may be replaced with another type of switching mechanism, such as a transistor.

As yet another example, the circuits of any one of FIGS. 11-14 may be modified for incorporation into a different portion of system 100 of FIG. 1. For example, rather than being adapted for the interfaces between (a) electrical panels 112 and 113 and control modules 122-125 and (b) EVs 131-134, the circuits of any one of FIGS. 11-14 may be adapted for the interface(s) between (a) electrical panel 111 and control module 121 and (b) at least one of (i) electrical panel 112 and control modules 122-124 and/or (ii) electrical panel 113 and control module 125. In such implementations, electrical panel 111 and control module 121 may control (a) which lines of an AC power source (e.g., electrical grid 140) are connected to electrical panels 112 and/or 113 (e.g., via power distribution lines 141), (b) what level of power is provided (e.g., power for level 1 or level 2 charging) to electrical panels 112 and/or 113, and/or (c) the number of phases of power delivered to electrical panels 112 and/or 113. In such implementations, control module 121 may be compared to the controller of FIGS. 9-14. Furthermore, the relays of FIGS. 9-14 may be incorporated into electrical panel 111. In some such implementations, the control circuitry and/or the CP and PP pins of FIGS. 9-14 may also be removed. For example, instead of transmitting a PWM signal, control module 121 may communicate with control modules 122-125 (e.g., via communication lines 161), as already described above in relation to FIGS. 1-8.

Advantageously, the circuits described above in relation to FIGS. 9-14 may enable a system to more effectively distribute, for example, the load of one or more EVs. The phases of an AC power source may not always be equally loaded. For example, as shown in FIG. 13, the controller may determine that lines 2 and 3 are more loaded than line 1 (e.g., by a factor or two or more). This may be due to an uneven residential load and/or an uneven load of one or more EVs. As a result, the controller may use line 1 (e.g., by closing relay 4 and opening relays 1-3, 5, and 6) to charge an EV. As another example, the controller may determine that line 3 is more loaded than lines 1 and 2 (e.g., by a factor or two or more). As a result, the controller may use lines 1 and 2 (e.g., by closing relay 1 and opening relays 2-6) to charge an EV. A similar set of controls can be also implemented by any of the controllers illustrated in FIGS. 11, 12, and/or 14. By more evenly distributing multiple loads across all the phases of an AC power source, a system can deliver more power to more devices simultaneously. When the load is an EV, this means that the system can more rapidly charge that EV.

From the foregoing and with reference to the various figure drawings, those skilled in the art will appreciate that certain modifications can also be made to the present disclosure without departing from the scope of the same. While several implementations of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular implementations. Those skilled in the art will envision other modifications within the scope and spirit of the claims appended hereto.

1. A system comprising:
a sensor for measuring a power drawn by a prioritized electrical load;
an electrical circuit for controlling and distributing power to an electric vehicle; and
one or more processors configured to:
receive, from the sensor, a measurement indicating the power drawn by the prioritized electrical load;
compare the power drawn by the prioritized electrical load to a predetermined threshold to determine an amount of power available for charging the electric vehicle; and
communicate, to the electric vehicle, the determined amount of power available for charging the electric vehicle.

2. The system of claim 1, wherein the predetermined threshold corresponds to a maximum amount of power that can be drawn by the prioritized electrical load.

3. The system of claim 1, wherein the prioritized electrical load comprises residential electrical devices.

4. The system of claim 1, wherein a single electrical panel comprises the electrical circuit, the one or more processors, and the sensor.

5. The system of claim 1, wherein the sensor comprises an RMS to DC converter, a current transformer, a Rogowski Coil, a shunt resistor, or a Hall effect current sensor.

6. The system of claim 1, further comprising:
an additional sensor for measuring a power drawn by the electric vehicle,
wherein the one or more processors are further configured to:
receive, from the additional sensor, a measurement indicating the power drawn by the electric vehicle; and
generate an alert when the power drawn by the electric vehicle is above a first predetermined threshold or below a second predetermined threshold.

7. The system of claim 1, further comprising:
an additional sensor for measuring a power drawn by the electric vehicle,
wherein the electrical circuit comprises one or more switches, and
wherein the one or more processors are further configured to:
receive, from the additional sensor, a measurement indicating the power drawn by the electric vehicle; and
control the one or more switches to automatically open when the power drawn by the electric vehicle is above a first predetermined threshold or below a second predetermined threshold.

8. The system of claim 1, wherein after communicating, to the electric vehicle, the determined amount of power available for charging the electric vehicle, the one or more processors are further configured to:
receive, from the sensor, an additional measurement indicating the power drawn by the prioritized electrical load;
adjust the determined amount of power available for charging the electric vehicle; and
communicate, to the electric vehicle, the adjusted amount of power available for charging the electric vehicle.

9. The system of claim 8, wherein the electrical circuit comprises one or more switches, and wherein the one or more processors are further configured to control the one or more switches to open before communicating, to the electric vehicle, the adjusted amount of power available for charging the electric vehicle.

10. The system of claim 9, wherein the one or more processors communicate the adjusted amount of power available for charging the electric vehicle through a pilot line of a J1772 connector.

11. The system of claim 1, further comprising:
a plurality of switching mechanisms that can be opened or closed to change at least one of (a) phases of an AC power source that are connected to the electric vehicle, (b) a level of power that is provided to the electric vehicle, or (c) a number of phases of power that are delivered to the electric vehicle,
wherein at least one of the sensor or an additional sensor is configured to measure loads on two or more of the phases of the AC power source, and
wherein the one or more processors are further configured to control the plurality of switching mechanisms to open or close based on the measured loads.

12. The system of claim 11, wherein the one or more processors are configured to control the plurality of switching mechanisms to connect the phase of the AC power source that is least loaded to the electric vehicle.

13. The system of claim 11, wherein the one or more processors are configured to control the plurality of switching mechanisms to provide level 2 charging to the electric vehicle when two or more of the phases of the AC power source are less loaded than one or more other phases of the AC power source.

14. The system of claim 11, wherein the one or more processors are configured to control the plurality of switching mechanisms to change how many phases of power are delivered to the electric vehicle.

15. A system comprising:
(a) a main power distribution and supervisory control module configured to:
(i) receive power from an electrical grid;
(ii) measure a power drawn by a prioritized electrical load; and
(iii) compare the power drawn by the prioritized electrical load to a predetermined threshold to determine an amount of power available for charging one or more electric vehicles; and
(b) a plurality of charging modules, each of which is configured to:
(i) receive power from the main power distribution and supervisory control module and distribute it to one or more connected electrical vehicles;
(ii) receive a communication from the main power distribution and supervisory control module indicating how much power can be collectively drawn by the one or more connected electrical vehicles; and
(iii) transmit a communication to each of the one or more connected electrical vehicles indicating how much power the corresponding electrical vehicle can draw.

16. The system of claim 15, wherein the power collectively received by the plurality of charging modules from the main power distribution and supervisory control module is less than or equal to the determined amount of power available for charging the one or more electric vehicles.

17. The system of claim 15, wherein the main power distribution and supervisory control module distributes more power to some of the plurality of charging modules.

18. A system comprising:
(a) a main power distribution and supervisory control module configured to:
(i) receive power from an electrical grid;
(ii) measure a power drawn by a prioritized electrical load; and
(iii) compare the power drawn by the prioritized electrical load to a predetermined threshold to determine an amount of power available for charging one or more electric vehicles;
(b) a block power distribution and supervisory control module configured to:
(i) receive power from the main power distribution and supervisory control module; and
(ii) receive a communication from the main power distribution and supervisory control module indicating how much power can be distributed by the block power distribution and supervisory control module; and
(c) a plurality of charging modules, each of which is configured to:
(i) receive power from the block power distribution and supervisory control module and distribute it to one or more connected electrical vehicles;
(ii) receive a communication from the block power distribution and supervisory control module indicating how much power can be collectively drawn by the one or more connected electrical vehicles; and
(iii) transmit a communication to each of the one or more connected electrical vehicles indicating how much power the corresponding electrical vehicle can draw.

19. The system of claim 18, wherein the power received by the block power distribution and supervisory control module from the main power distribution and supervisory control module is less than or equal to the determined amount of power available for charging the one or more electric vehicles.

20. The system of claim 18, wherein the block power distribution and supervisory control module distributes more power to some of the plurality of charging modules.
